(19) United States
(12) Patent Application Publication
(10) Pub. No.: US 2020/0401943 A1
(43) Pub. Date: Dec. 24, 2020

(54) MODEL LEARNING APPARATUS, MODEL LEARNING METHOD, AND PROGRAM

(71) Applicant: NIPPON TELEGRAPH AND TELEPHONE CORPORATION, Tokyo (JP)

(72) Inventors: Yuta KAWACHI, Tokyo (JP); Yuma KOIZUMI, Tokyo (JP); Noboru HARADA, Tokyo (JP)

(73) Assignee: NIPPON TELEGRAPH AND TELEPHONE CORPORATION, Tokyo (JP)

(21) Appl. No.: 16/969,145

(22) PCT Filed: Feb. 13, 2019
(86) PCT No.: PCT/JP2019/004930

§ 371 Date: Aug. 11, 2020

(30) Foreign Application Priority Data
Feb. 13, 2018 (JP) 2018-022978

(51) Int. Cl. G06N 20/00; G06K 9/62; G06F 17/16

(52) U.S. Cl. CPC G06N 20/00; G06F 17/16; G06K 9/628

(57) ABSTRACT

There is provided a model learning technique for learning a model which performs classification into three values by model learning using an AUC optimization criterion. A model learning unit is included which learns a parameter ψ^{\hat{ }} of a model by using a learning data set based on a criterion which uses a predetermined AUC value, the learning data set being defined using normal data generated from sound observed in a normal state and abnormal data generated from sound observed in an abnormal state, and the AUC value is defined from a difference between an abnormality degree of the normal data and an abnormality degree of the abnormal data using a two-stage step function T(x).

### TECHNICAL FIELD

The present invention relates to a model learning technique for learning a model used to detect abnormality from observed data, such as to detect failure from operation sound of a machine.

### BACKGROUND ART

For example, it is important in terms of continuity of services to find failure of a machine before the failure occurs, or to quickly find it after the failure occurs. As a method for saving labor for this, there is a technical field called abnormality detection for finding “abnormality”, which is deviation from the normal state, from data acquired using a sensor (hereinafter referred to as sensor data) by using an electric circuit or a program. In particular, abnormality detection using a sensor for converting sound into an electric signal such as a microphone is called abnormal sound detection. Abnormality detection can be similarly performed for any abnormality detection domain which targets any sensor data other than sound such as temperature, pressure, or displacement, or traffic data such as a network communication amount.

Learning of a model used for abnormality detection is roughly classified into unsupervised learning which uses only normal data, and supervised learning which uses both of normal and abnormal data such as AUC optimization as in Non-Patent Literature 1 and Non-Patent Literature 2. In either case, a binary classifier is learned which classifies input data into normal or abnormal data.

### CITATION LIST

### Non-Patent Literature

Non-Patent Literature 1: Akinori Fujino and Naonori Ueda, “A Semi-Supervised AUC Optimization Method with Generative Models”, 2016 IEEE 16th International Conference on Data Mining (ICDM), IEEE, pp. 883-888, 2016.
Non-Patent Literature 2: Alan Herschtal and Bhavani Raskutti, “Optimising area under the ROC curve using gradient descent”, ICML '04, Proceedings of the twenty-first international conference on Machine learning, ACM, 2004.

### SUMMARY OF THE INVENTION

### Technical Problem

However, third output such as indistinguishability may be provided in addition to normality and abnormality, and when the third output is output, a suitable approach may be that a human visually judges input data. In such a case, normal data and abnormal data have similar features, and even through a normal label or an abnormal label is given to data, indistinguishable data is present in practice. When such data is present, a mismatch with reality occurs because supervised learning tries to learn a model which forcibly performs classification into either normality or abnormality, giving adverse effect on detection performance. Although unsupervised learning can perform learning so as to perform classification into three values, data given the abnormal label (abnormal data) cannot be used in this case, so that the amount of learning data is reduced, and adverse effect is given on abnormality detection performance.

Accordingly, an object of the present invention is to provide a model learning technique for learning a model which performs classification into three values by model learning using an AUC optimization criterion.

### Means for Solving the Problem

An aspect of the present invention includes a model learning unit which learns a parameter ψ^{\hat{ }} of a model by using a learning data set based on a criterion which uses a predetermined AUC value, the learning data set being defined using normal data generated from sound observed in a normal state and abnormal data generated from sound observed in an abnormal state, and the AUC value is defined from a difference between an abnormality degree of the normal data and an abnormality degree of the abnormal data using a two-stage step function T(x).

An aspect of the present invention includes a model learning unit which learns a parameter ψ^{\hat{ }} of a model by using a learning data set based on a criterion which uses a predetermined AUC value, the learning data set being defined using normal data generated from data observed in a normal state and abnormal data generated from data observed in an abnormal state, and the AUC value is defined from a difference between an abnormality degree of the normal data and an abnormality degree of the abnormal data using a two-stage step function T(x).

### Effects of the Invention

According to the present invention, it is made possible to learn a model which performs classification into three values by model learning using an AUC optimization criterion.

### BRIEF DESCRIPTION OF DRAWINGS

FIG. 1 is a diagram showing the appearance of a two-stage step function and its approximate function.

FIG. 2 is a block diagram showing an example configuration of a model learning device 100.

FIG. 3 is a flowchart showing an example operation of the model learning device 100.

FIG. 4 is a block diagram showing an example configuration of an abnormality detection device 200.

FIG. 5 is a flowchart showing an example operation of the abnormality detection device 200.

### DETAILED DESCRIPTION OF THE INVENTION

An embodiment of the present invention will be described below in detail. Note that constituent units having the same function are given the same number, and duplicate description will be omitted.

Model learning using the AUC optimization criterion uses a step function which can represent it with a binary value of 0 or 1 whether normality or abnormality has correctly been discriminated or not. Accordingly, in the embodiment of the present invention, an intermediate constant between 0 and 1 is introduced as representing a third state which represents indistinguishability. Specifically, instead of the step function, a two-stage step function is used which is defined as the maximum of two step functions with shifted domains and ranges. Three-valued classification is realized by using two types of approximation, that is, differentiable functional approximation of a maximum function used to form this two-stage step function and approximation of the step function used to form the two-stage step function, to define an AUC value with a function which can be continuously optimized using a gradient method, a subgradient method, or the like.

### TECHNICAL BACKGROUND

Unless otherwise specified, lower-case variables appearing in the following description shall represent scalars or (vertical) vectors.

In order to learn a model having a parameter ψ, a set of abnormal data X⁺={xᵢ⁺| i∈[1, . . . N⁺]} and a set of normal data X⁻={xⱼ⁻|j∈[1, . . . , N⁻]} are prepared. An element of each set corresponds to one sample of a feature amount vector or the like.

A direct product set X={(xᵢ⁺, xⱼ⁻)| i∈[1, . . . , N⁺], j∈[1, . . . , N⁻]} of the abnormal data set X⁺ and the normal data set X⁻ whose number of elements is N=N⁺×N⁻ is regarded as a learning data set. At this time, an (empirical) AUC value is given by the following expression:

$$\begin{matrix}[ Formula 1 ] & \\ AUC [ X , ψ ] = \frac{1}{N} {\sum }_{i , j} H ( I ( {x}_{i}^{+} ; ψ ) - I ( {x}_{j}^{-} ; ψ ) ) & ( 1 )\end{matrix}$$

Note that the function H(x) is a (Heaviside) step function. That is, the function H(x) is a function which returns 1 when the value of the argument x is greater than 0, and returns 0 when it is less than 0. The function I(x; ψ) is a function which has a parameter ψ, and returns an abnormality degree corresponding to the argument x. Note that the value of the function I(x; ψ) corresponding to x is a scalar value, and may be called the abnormality degree of x.

Expression (1) represents that a model is preferable in which for any pair of abnormal data and normal data, the abnormality degree of the abnormal data is greater than the abnormality degree of the normal data. The value of Expression (1) becomes the maximum when the abnormality degree of abnormal data is greater than the abnormality degree of normal data for all pairs, and then the value becomes 1. A criterion for calculating the parameter ψ which maximizes (i.e., optimizes) this AUC value is the AUC optimization criterion.

Three-valued classification is realized by replacing the step function in the AUC optimization criterion with the two-stage step function. Note that classification into any number of values can be realized in a similar manner. That is, if an (n−1)-stage step function is used, n-valued classification becomes possible.

Three-valued classification will be described below. For example, a two-stage step function T(x) provided with a step having a width of 2h(>0) and a height of 0.5 is as follows:

[Formula 2]

T(x)=max(H(x−h),0.5×H(x+h)) (2)

Note that h is a hyperparameter, and its value is determined in advance.

Generally, let h₁ and h₂ be real numbers satisfying h₁>0 and h₂>0, respectively, and let α be a real number satisfying 0<α<1, then the two-stage step function T(x) can be defined as follows:

[Formula 3]

T(x)=max(H(x−h₁),α×H(x+h₂)) (3)

That is, the two-stage step function T(x) is a function which takes a value of 1 when x>h₁, a value of α when h₁>x>h₂, and a value of 0 when h₂>x, so it can be said as a function provided with a step having a width of h₁+h₂ and a height of α.

Instead of the function H(x) in Expression (1), the function T(x) in Expression (2) or Expression (3) is used to define the AUC value as follows:

$$\begin{matrix}[ Formula 4 ] & \\ AUC [ X , ψ ] = \frac{1}{N} {\sum }_{i , j} T ( I ( {x}_{i}^{+} ; ψ ) - I ( {x}_{j}^{-} ; ψ ) ) & ( 4 )\end{matrix}$$

However, since Expression (4) is indifferentiable, optimization using a gradient method or the like is difficult. So, the maximum function max(x, y) used in Expression (2) and Expression (3) is approximated as follows:

[Formula 5]

max(x,y)≅ln(exp(x)+exp(y)) (5)

max(x,y)≅½{x+y+\sqrt{(x−y)²+1}} (5′)

Of course, approximation other than Expression (5) and Expression (5′) may be used. That is, any function may be used as long as it is a differentiable function which approximates the maximum function max(x, y). A differentiable function which approximates the maximum function max(x, y) will be denoted below as S(x).

Hereinafter, S(x) is assumed to be the right-hand function of Expression (5), and explanation will be given taking, as an example, approximation of the function T (x) using this S (x) (Expression (6)).

[Formula 6]

T(x)≅ln(exp(H(x−h))+exp(0.5×H(x+h))) (6)

An approximate function of the step function H(x) is further introduced here. Although various methods are known as an approximate method for the step function (e.g., see Non-Patent Literature 1 and Non-Patent Literature 2), approximation methods using a ramp function and a softplus function will be described below. (See Non-Patent Literature 1: Charanpal Dhanjal, Romaric Gaudel and Stephan Clemencon, “AUC Optimisation and Collaborative Filtering”, arXiv preprint, arXiv:1508.06091, 2015.) (See Non-Patent Literature 2: Stijn Vanderlooy and Eyke Hullermeier, “A critical analysis of variants of the AUC”, Machine Learning, Vol. 72, Issue 3, pp. 247-262, 2008.)

(A variant of) the ramp function ramp′(x) restricting the maximum is given by the following expression:

$$\begin{matrix}[ Formula 7 ] & \\ {ramp}^{′} ( x ) = \{ \begin{matrix}1 & ( x > 0 ) \\ x + 1 & ( x \leq 0 )\end{matrix} & ( 7 )\end{matrix}$$

(A variant of) the softplus function softplus′(x) is given by the following expression:

[Formula 8]

softplus′(x)=1−ln(1+exp(−x)) (8)

The function in Expression (7) is a function for linearly giving a cost when the abnormality degrees are reversed, and the function in Expression (8) is a differentiable approximate function.

When the softplus function in Expression (8) is used, Expression (6) becomes as follows:

$$\begin{matrix}[ Formula 9 ] & \\ T ( x ) \tilde{=} ln ( \frac{e}{1 + exp ( - ( x - h ) )} + \sqrt{\frac{e}{1 + exp ( - ( x + h ) )}} ) & ( 9 )\end{matrix}$$

When a hyperparameter C for controlling the magnitude of gradient is introduced, Expression (9) becomes as follows:

$$\begin{matrix}[ Formula 10 ] & \\ T ( x ) \tilde{=} ln ( \frac{e}{1 + exp ( - C ( x - h ) )} + \sqrt{\frac{e}{1 + exp ( - C ( x + h ) )}} ) & ( 10 )\end{matrix}$$

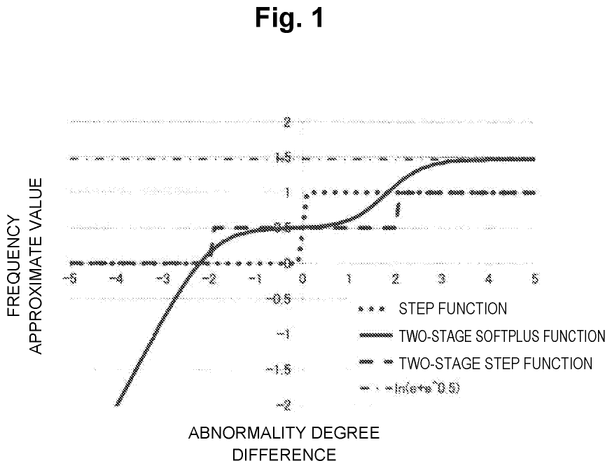

The maximum of both of the right-hand functions of Expression (9) and Expression (10) is not 1 but ln(e+√e), and therefore when the AUC value is calculated, it may be adjusted by dividing it by this value so that the maximum may become 1. FIG. 1 shows the appearance of the two-stage step function and its approximate function.

### First Embodiment

(Model Learning Device 100)

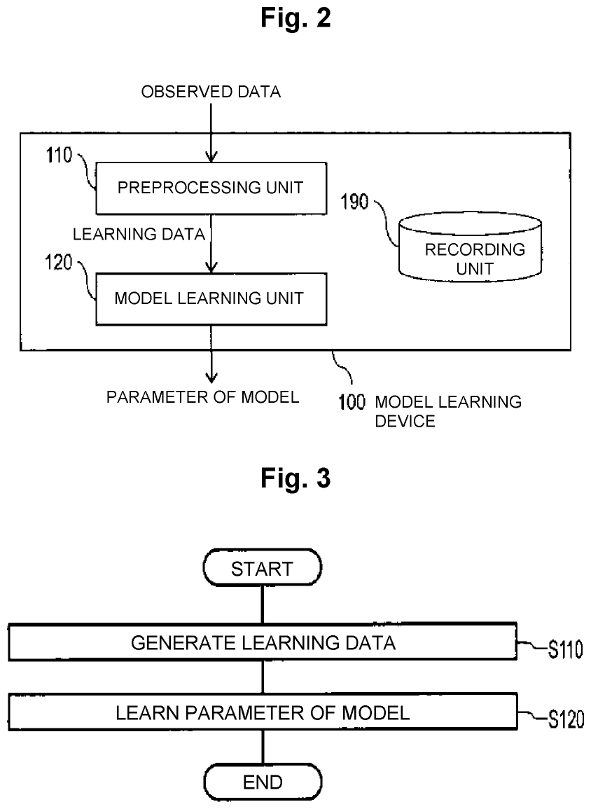

A model learning device 100 will be described below with reference to FIGS. 2-3. FIG. 2 is a block diagram showing a configuration of a model learning device 100. FIG. 3 is a flowchart showing operation of the model learning device 100. As shown in FIG. 2, the model learning device 100 includes a preprocessing unit 110, a model learning unit 120, and a recording unit 190. The recording unit 190 is a constituent unit which appropriately records information necessary for processing in the model learning device 100.

The operation of the model learning device 100 will be described below in accordance with FIG. 3.

In S110, the preprocessing unit 110 generates learning data from observed data. When abnormal sound detection is targeted, the observed data is sound observed in the normal state or sound observed in the abnormal state, such as a sound waveform of normal operation sound or abnormal operation sound of a machine. Thus, whatever field is targeted for abnormality detection, the observed data includes both of data observed in the normal state and data observed in the abnormal state.

The learning data generated from the observed data is generally represented as a vector. When abnormal sound detection is targeted, the observed data, that is, sound observed in the normal state or sound observed in the abnormal state is A/D(analog-to-digital)-converted at a suitable sampling frequency to generate quantized waveform data. The thus-quantized waveform data may be directly used to regard data in which one-dimensional values are arranged in time series as the learning data; data subjected to feature extraction processing for extension into multiple dimensions using concatenation of multiple samples, discrete Fourier transform, filter bank processing, or the like may be used as the learning data; or data subjected to processing such as normalization of the range of possible values by calculating the average and variance of data may be used as the learning data. When a field other than abnormal sound detection is targeted, it is sufficient to perform similar processing for a continuous amount such as temperature and humidity or a current value, and it is sufficient to form a feature vector using numeric values or 1-of-K representation and perform similar processing for a discrete amount such as a frequency or text (e.g., characters, word strings).

Note that learning data generated from observed data in the normal state is referred to as normal data, and learning data generated from observed data in the abnormal state is referred to as abnormal data. The abnormal data set is denoted as X⁺={xᵢ⁺| i∈[1, . . . , N⁺]}, and the normal data set is denoted as X⁻={xⱼ⁻| j∈[1, . . . , N⁻]}. As described in <Technical Background>, a direct product set X={(xᵢ⁺, xⱼ⁻)| i∈[1, . . . , N⁺], j∈[1, . . . , N⁻]} of the abnormal data set X⁺ and the normal data set X⁻ is referred to as a learning data set. The learning data set is a set defined using the normal data and the abnormal data.

In S120, the model learning unit 120 learns a parameter ψ^{\hat{ }} of the model by using the learning data set defined using the normal data and the abnormal data generated in S110, based on a criterion which uses a predetermined AUC value.

Here, the AUC value is calculated from a difference between the abnormality degree of the normal data and the abnormality degree of the abnormal data using the two-stage step function T(x), and is calculated by, for example, Expression (4).

The AUC value may be calculated using the approximation of the function T(x) such as in Expression (9) and Expression (10). The hyperparameters h and C appearing in the right-hand side of Expression (9) and Expression (10) are predetermined constants. Note that the values of h and C may be values obtained by performing learning similar to this step on some candidate values, and making a selection based on the AUC optimization criterion or the like, or may be values which are empirically known to be excellent.

When the model learning unit 120 learns the parameter ψ^{\hat{ }} using the AUC value, the AUC optimization criterion is used for learning. In this way, for a model having the parameter ψ, it is possible to calculate the parameter ψ^{\hat{ }} which is an optimum value of ψ. At that time, the values of the hyperparameters h and C may be changed in the middle of learning. For example, learning can be facilitated by gradually increasing the hyperparameter C for controlling the magnitude of gradient.

(Abnormality Detection Device 200)

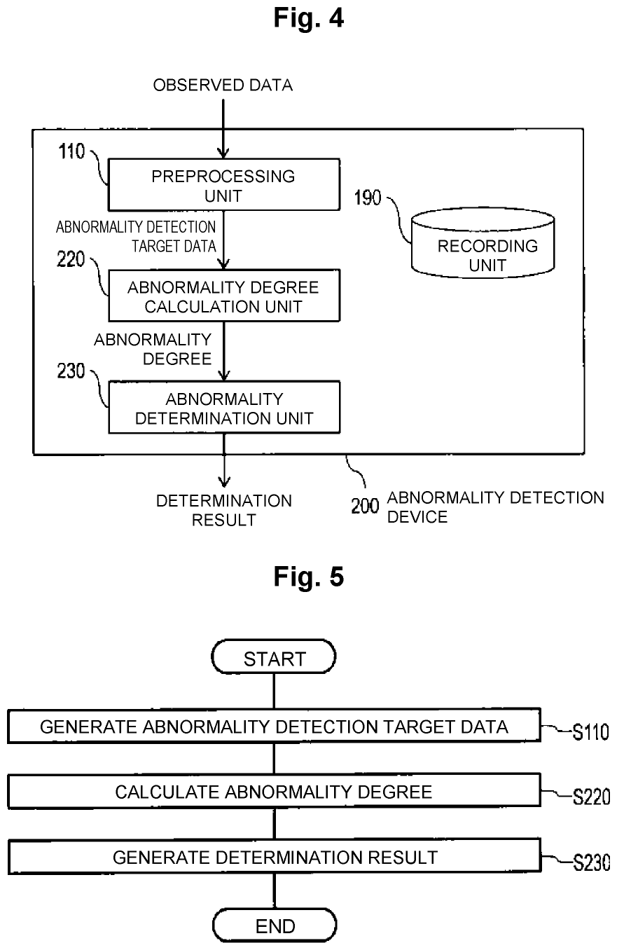

The abnormality detection device 200 will be described below with reference to FIGS. 4-5. FIG. 4 is a block diagram showing a configuration of the abnormality detection device 200. FIG. 5 is a flowchart showing operation of the abnormality detection device 200. As shown in FIG. 4, the abnormality detection device 200 includes the preprocessing unit 110, an abnormality degree calculation unit 220, an abnormality determination unit 230, and the recording unit 190. The recording unit 190 is a constituent unit which appropriately records information necessary for processing in the abnormality detection device 200. For example, the parameter ψ^{\hat{ }} generated by the model learning device 100 is recorded in advance.

The operation of the abnormality detection device 200 will be described below in accordance with FIG. 5.

In S110, the preprocessing unit 110 generates abnormality detection target data from observed data targeted for abnormality detection. Specifically, the abnormality detection target data x is generated in the same way as when the preprocessing unit 110 of the model learning device 100 generates learning data.

In S220, the abnormality degree calculation unit 220 calculates an abnormality degree from the abnormality detection target data x generated in S110 using the parameter ψ^{\hat{ }} recorded in the recording unit 190. For example, the abnormality degree I(x) can be defined as I(x)=I(x;ψ^{\hat{ }}).

In S230, the abnormality determination unit 230 generates, from the abnormality degree calculated in S220, a determination result indicating whether the observed data, which is input and targeted for abnormality detection, is normal, abnormal, or indistinguishable. For example, using predetermined thresholds a and b (a>b), a determination result indicating abnormality is generated when the abnormality degree is equal to or greater than the threshold a (or greater than the threshold a), a determination result indicating normality is generated when the abnormality degree is equal to or less than the threshold b (or less than the threshold b), or otherwise a determination result indicating indistinguishability is generated.

Note that in order to determine the thresholds for three-valued classification, it is possible to prepare small amounts of data of three kinds, which are normal, indistinguishable, and abnormal, and determine the two thresholds so as to increase discrimination performance among them (such as an F1 value for multi-valued classification). The thresholds may be adjusted or determined manually in response to a request from services related to abnormality detection.

When a determination result indicating indistinguishability is generated, it is possible to notify an expert to perform escalation to a human, and allow the expert to make a decision by visual inspection or the like, thereafter determining the determination result.

(Variant)

Model learning based on the AUC optimization criterion performs model learning so as to optimize a difference between the abnormality degree for the normal data and the abnormality degree for the abnormal data. Accordingly, for pAUC optimization similar to AUC optimization (see Non-Patent Literature 3), or for another method for optimizing a value (which corresponds to the AUC value) defined using the difference between the abnormality degrees, model learning is possible by performing similar replacement as described in <Technical Background>.

(See Non-Patent Literature 3: Harikrishna Narasimhan and Shivani Agarwal, “A structural SVM based approach for optimizing partial AUC”, Proceeding of the 30th International Conference on Machine Learning, pp. 516-524, 2013.)

According to the invention of this embodiment, model learning using the AUC optimization criterion enables learning of a model which performs classification into three values. By extending the AUC optimization criterion, which is a learning criterion for a binary classification model into normality and abnormality, to classification into three values including indistinguishability, it is possible to entrust distinction to a human in a case where normality and abnormality are difficult to distinguish. At that time, it is sufficient to prepare only data given two kinds of labels (i.e., abnormal data and normal data) as large-scale learning data, and it takes almost no cost to attach a new label corresponding to indistinguishability.

<Supplement>

For example, as a single hardware entity, an device of the present invention has: an input unit to which a keyboard or the like is connectable; an output unit to which a liquid crystal display or the like is connectable; a communication unit to which a communication device (e.g., a communication cable) capable of communicating with the outside of the hardware entity is connectable; a CPU (central processing unit, which may be provided with a cache memory, a register, or the like); a RAM or a ROM which is a memory; an external storage device which is a hard disk; and a bus which connects the input unit, the output unit, the communication unit, the CPU, the RAM, the ROM, and the external storage device to each other so that they can exchange data. In addition, as necessary, the hardware entity may be provided with, for example, an device (drive) which can perform reading/writing from/to a recording medium such as a CD-ROM. Physical entities provided with such hardware resources includes a general-purpose computer.

The external storage device of the hardware entity stores a program necessary for realizing the above function, data necessary in processing of this program, and the like (this is not limited to an external storage device, and the program may be stored in, for example, a ROM which is a read-only storage device). Data and the like obtained by the processing of these programs are appropriately stored in the RAM, the external storage device, or the like.

In the hardware entity, each program stored in the external storage device (or the ROM, etc.) and data necessary for processing of this each program are read to the memory as necessary, and interpretation, execution, and processing are performed by the CPU as appropriate. As a result, the CPU realizes a predetermined function (each constituent element represented as . . . unit, . . . means, or the like as described above).

The present invention is not limited to the above embodiment, and can be modified as appropriate within the range not deviating from the spirit of the present invention. The processing described in the above embodiment may be executed not only in time series according to the order described, but also parallelly or individually depending on the processing performance of a device executing the processing or as necessary.

As already mentioned, when the processing function in the hardware entity (the device of the present invention) as described in the above embodiment is realized by a computer, processing contents of a function which the hardware entity should have are written in a program. Then, by executing this program on a computer, the processing function in the above hardware entity is realized on the computer.

A program in which these processing contents are written can be recorded in a computer-readable recording medium. The computer-readable recording medium may be any medium such as a magnetic recording device, an optical disc, a magneto-optical recording medium, a semiconductor memory, or the like. Specifically, for example, a hard disk device, a flexible disk, a magnetic tape, or the like may be used as a magnetic recording device; DVD (digital versatile disc), DVD-RAM (random access memory), CD-ROM (compact disc read only memory), CD-R (recordable)/RW (rewritable), or the like as an optical disc; an MO (magneto-optical disc) or the like as a magneto-optical recording medium; and an EEP-ROM (electronically erasable and programmable-read only memory) or the like as a semiconductor memory.

This program is distributed by, for example, selling, handing over, or lending a portable recording medium such as a DVD, a CD-ROM, or the like on which the program is recorded. Furthermore, a configuration is possible in which this program is distributed by storing this program in a storage device of a server computer in advance, and transferring the program from the server computer to another computer via a network.

For example, a computer which executes such a program first temporarily stores the program recorded on the portable recording medium or the program transferred from the server computer in its own storage device. Then, when executing processing, this computer reads the program stored in its own recording medium, and executes processing according to the read program. As another execution form of this program, the computer may read the program directly from the portable recording medium, and execute the processing according to the program, and furthermore, each time the program is transferred from the server computer to this computer, the processing according to the received program may be executed sequentially. A configuration is possible in which the above processing is executed by a so-called ASP (application service provider)-type service which does not transfer the program from the server computer to this computer, but realizes the processing function only by its execution instruction and acquisition of results. Note that the program in this embodiment shall include information which is provided for processing by an electronic computer, and is equivalent to the program (although this is not a direct command for the computer, it is data having property specifying the processing of the computer or the like).

Although this embodiment configures the hardware entity by executing a predetermined program on a computer, at least part of these processing contents may be realized in a hardware manner.

1.-8. (canceled)

9. A computer-implemented method for model learning for three-valued classification, the method comprising:
generating normal data for learning positive results;
generating abnormal data for learning negative results;
generating a learning data set based on the normal data and the abnormal data;
learning a classification model using the generated learning data set based on a predetermined area under-the-receiver-operating-characteristic curve (AUC) values, wherein the AUC values are based at least on a difference between a first abnormality degree of the normal data and a second abnormality degree of the abnormal data using a two-stage step operation.

10. The computer-implemented method of claim 9, wherein the AUC values are based on an average of a combination of the two-stage step operation and the difference between the first abnormality degree of the normal data and the second abnormality degree of the abnormal data, and wherein the two-stage step operation relates to states of normal, abnormal, and indistinguishable

11. The computer-implemented method of claim 10, wherein the two-stage step operations are differentiable.

12. The computer-implemented method of claim 9, wherein the learning of a parameter of a classification model uses an AUC optimization criterion with the two-stage step calculation.

13. The computer-implemented method of claim 9, the method further comprising:
receiving normal data, the normal data representing data in a normal status;
receiving abnormal sound data, the abnormal data representing data in an abnormal status, the abnormal sound data and the normal sound data being distinct;
generating the normal data based on the normal sound data using vector conversion; and
generating the abnormal data based on the abnormal sound data using vector conversion.

14. The computer-implemented method of claim 9, wherein, based on the two-stage step calculation, the classification model provides a three-valued classification, the three-valued classification includes:
a normal class,
an abnormal class, and
an indistinguishable class.

15. The computer-implemented method of claim 14, wherein the normal data represent normal sound data indicating sound of an object operating in a normal status, wherein the abnormal data represent abnormal sound data indicating sound the object operating in an abnormal status, and wherein the indistinguishable class represents an escalation status requiring visual inspections of the object.

16. A system for a three-valued classification, the system comprising:
a processor; and
a memory storing computer-executable instructions that when executed by the processor cause the system to:
generate normal data for learning positive results;
generate abnormal data for learning negative results;
generate a learning data set based on the normal data and the abnormal data;
learn a classification model using the generated learning data set based on a predetermined area under-the-receiver-operating-characteristic curve (AUC) values, wherein the AUC values are based at least on a difference between a first abnormality degree of the normal data and a second abnormality degree of the abnormal data using a two-stage step operation.

17. The computer-implemented method of claim 16, wherein the AUC values are based on an average of a combination of the two-stage step operation and the difference between the first abnormality degree of the normal data and the second abnormality degree of the abnormal data, and wherein the two-stage step operation relates to states of normal, abnormal, and indistinguishable.

18. The system of claim 17, wherein the two-stage step operations are differentiable.

19. The system of claim 16, wherein the learning of a parameter ψ^{\hat{ }} of a classification model uses an AUC optimization criterion with the two-stage step calculation.

20. The system of claim 16, the computer-executable instructions when executed further causing the system to:
receive normal data, the normal data representing data in a normal status;
receive abnormal sound data, the abnormal data representing data in an abnormal status, the abnormal sound data and the normal sound data being distinct;
generate the normal data based on the normal sound data using vector conversion; and
generate the abnormal data based on the abnormal sound data using vector conversion.

21. The system of claim 16, wherein, based on the two-stage step calculation, the classification model provides a three-valued classification, the three-valued classification includes:
a normal class,
an abnormal class, and
an indistinguishable class.

22. The system of claim 21, wherein the normal data represent normal sound data indicating sound of an object operating in a normal status, wherein the abnormal data represent abnormal sound data indicating sound the object operating in an abnormal status, and wherein the indistinguishable class represents an escalation status requiring visual inspections of the object.

23. A computer-readable non-transitory recording medium storing computer-executable instructions that when executed by a processor cause a computer system to:
generate normal data for learning positive results;
generate abnormal data for learning negative results;
generate a learning data set based on the normal data and the abnormal data;
learn a classification model using the generated learning data set based on a predetermined area under-the-receiver-operating-characteristic curve (AUC) values, wherein the AUC values are based at least on a difference between a first abnormality degree of the normal data and a second abnormality degree of the abnormal data using a two-stage step operation.

24. The computer-readable non-transitory recording medium of claim 23, wherein the AUC values are based on an average of a combination of the two-stage step operation and the difference between the first abnormality degree of the normal data and the second abnormality degree of the abnormal data, and wherein the two-stage step operation relates to states of normal, abnormal, and indistinguishable.

25. The computer-readable non-transitory recording medium of claim 23, wherein the two-stage step operations are differentiable.

26. The computer-readable non-transitory recording medium of claim 23, wherein the learning of a parameter of a classification model uses an AUC optimization criterion with the two-stage step calculation.

27. The computer-readable non-transitory recording medium of claim 23, the computer-executable instructions when executed further causing the system to:
receive normal data, the normal data representing data in a normal status;
receive abnormal sound data, the abnormal data representing data in an abnormal status, the abnormal sound data and the normal sound data being distinct;
generate the normal data based on the normal sound data using vector conversion; and
generate the abnormal data based on the abnormal sound data using vector conversion.

28. The computer-readable non-transitory recording medium of claim 23, wherein, based on the two-stage step calculation, the classification model provides a three-valued classification, the three-valued classification includes:
a normal class,
an abnormal class, and
an indistinguishable class.
